(19) United States
(12) Patent Application Publication
(10) Pub. No.: US 2008/0054137 A1
(43) Pub. Date: Mar. 6, 2008

(54) Attachment bracket for installing windows and doors

(76) Inventor: Serge Poulin, La Plaine (CA)

Correspondence Address: INVENTARIUM, SUITE 1607, 4050, ROSEMONT, MONTREAL, QC, H1X1M4, US

(21) Appl. No.: 11/845,656

(22) Filed: Aug. 27, 2007

Related U.S. Application Data
(60) Provisional application No. 60/842,525, filed on Sep. 6, 2006.

(51) Int. Cl. E06B 7/28

(52) U.S. Cl. 248/208

(57) ABSTRACT

A simple and efficient window or door installation system that can replace wedges by using specially shaped and configured brackets that provide an interface between a window or door and its frame.

This application claims priority based on provisional application 60/842,525 filed Sep. 6, 2006

### FIELD OF THE INVENTION

The invention relates generally to attachment brackets but more particularly to brackets used for holding windows or doors during installation.

### BACKGROUND OF THE INVENTION

It is a difficult process to quickly install windows on bare frames during the construction of a house or during a renovation project. The window must not tilt outwardly or inwardly and must be level with the rest of the building. Also, some gaps must be maintained so as to insert leveling wedges, then the screws that will permanently fix the window to the structure. During all these steps, if the window cannot be kept in position, it may lose its level and end up installed in a crooked way. It is therefore important to have a practical and efficient device to keep a window steady during installation. Moreover, if the device can also be used to permanently anchor the window or door casing in place, all the better.

There exist, of course, many types of brackets and anchoring devices but none offer a simple way of easily marking the exact position the casing must have in order to fit perfectly with the interior finishing of a dwelling, such as being flush with the sheet of drywall for example.

### SUMMARY OF THE INVENTION

In view of the foregoing disadvantages inherent in the known devices now present in the prior art, the present invention, which will be described subsequently in greater detail, is to provide the feature and benefit of presenting a simple and efficient window installation system that can replace wedges.

To attain these ends, the present invention generally comprises an attachment bracket for positioning a window or door casing having a long section and a short section. The short section has teeth for tacking the attachment bracket to the window casing. Stud guides to provide positioning of the window casing relative to framing studs. The short section teeth also are used for positioning the attachment bracket onto a finished interior wall. Holes made into the attachment bracket to allow mechanical fateners to attach the attachment bracket.

The attachment bracket has a method of installation consisting of the steps of tacking and mechanically fastening one attachment bracket on one side of the bottom of the window casing using short section teeth with the stud guides being positioned just off the window casing's edge towards the interior of the dwelling. Tacking and mechanically fastening a second attachment bracket on the same side and in a similar fashion but at the top of the window casing also installed using short section teeth with the stud guides being positioned just off the window casing's edge towards the interior of the dwelling. Tacking and mechanically fastening two more attachment brackets on the opposite side of the window casing with one at the bottom of the window casing and the other at the top of the window casing also installed using short section teeth with the stud guides being positioned just off the window casing's edge towards the interior of the dwelling. Mechanically fastening one of the four attachment bracket to a stud. Leveling the window casing. Mechanically fastening the second attachment bracket, and mechanically fastening the remaining attachment brackets.

The method of installation of a window casing as a replacement for an existing window has a method of installation consisting of the steps of tacking and mechanically fastening one attachment bracket on one side of the bottom of the window casing so that the long section, with the help of the short section teeth, is positioned in such a way that when set against the finished wall the window casing is flush with the finished interior wall. Tacking and mechanically fastening a second attachment bracket on the same side and in a similar fashion but at the top of the window casing also installed using short section teeth with the stud guides being positioned just off the window casing's edge towards the interior of the dwelling Tacking and mechanically fastening two more attachment brackets on the opposite side of the window casing with one at the bottom of the window casing and the other at the top of the window casing also installed using short section teeth with the stud guides being positioned just off the window casing's edge towards the interior of the dwelling. Mechanically fastening one of the four attachment bracket to a stud. Leveling the window casing Mechanically fastening the second attachment bracket, and mechanically fastening the remaining attachment brackets.

Although the primary use is for windows, an artisan well versed in the field can realize that the same system can also be used for installing doors but in the interest of brevity, the word windows is used throughout.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Isometric views of the attachment bracket installed on a bare wall and installed on a finished wall, respectively

FIGS. 2a-d Isometric view, reverse isometric view, isometric view of the back and reverse isometric view of the back of the attachment bracket, respectively.

FIGS. 3a-b Front and top views, respectively, of the attachment bracket.

FIG. 4a-b Side cutaway view along A-A and side view detail, respectively, of the attachment bracket.

### DETAILED DESCRIPTION

An attachment bracket (10) has an <<L>> shape with a long section (12) and a short section (14). When used for installing a window on bare walls, the attachment bracket (10) is first tacked to the window casing (16), using short section teeth (26) with the stud guides (18) being positioned just off the window casing's edge (20) towards the interior of the dwelling. In this fashion, the stud guides (18) provide the proper positioning of the attachment bracket (10) which in turn, provides for the proper positioning of the window casing (16) in relation with the framing studs (22). This template of sort will make the window casing (16) come flush with a future finished interior wall (24).

By putting one attachment bracket (10) at the bottom of the window casing (16) and another one at the top of the window casing (16), this insures that the window casing (16) is not tilted inwardly or outwardly. Also by fixedly attaching one attachment bracket (10) to the framing stud (22), the window casing (16) can be leveled horizontally, and then, the attachment bracket (10) situated on the opposite side of the window casing (16) can also be fixedly attached to the framing stud (22) so as to provide for a leveled window casing (16) along both the horizontal X axis and the vertical Y axis. Finally, the remaining two attachment brackets (10) located at the top of the window casing (16) can be fixedly attached to the framing studs (22), so as to maintain the proper alignment of the window casing along the Z axis so that all axes (X,Y,Z) are perpendicular to one another and the window casing (16) is securedly attached to the studs (22) by four points of attachment.

With the window casing (16) thus leveled on all three axes and set so that it will be flush with the finished interior wall (24), the rest of the construction can be done as usual.

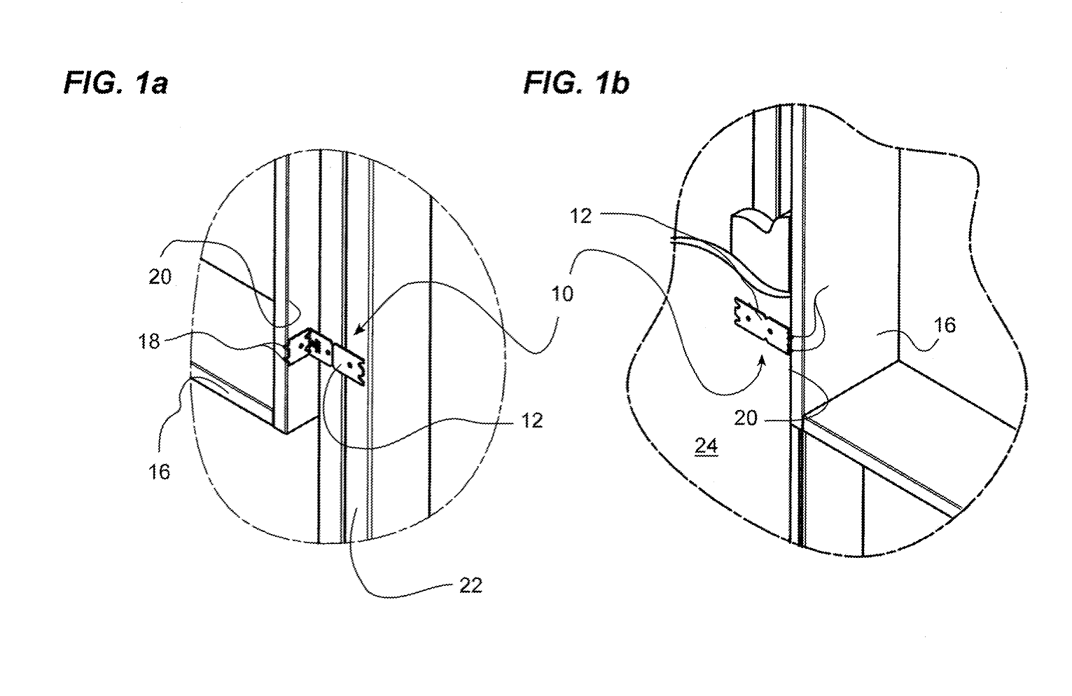

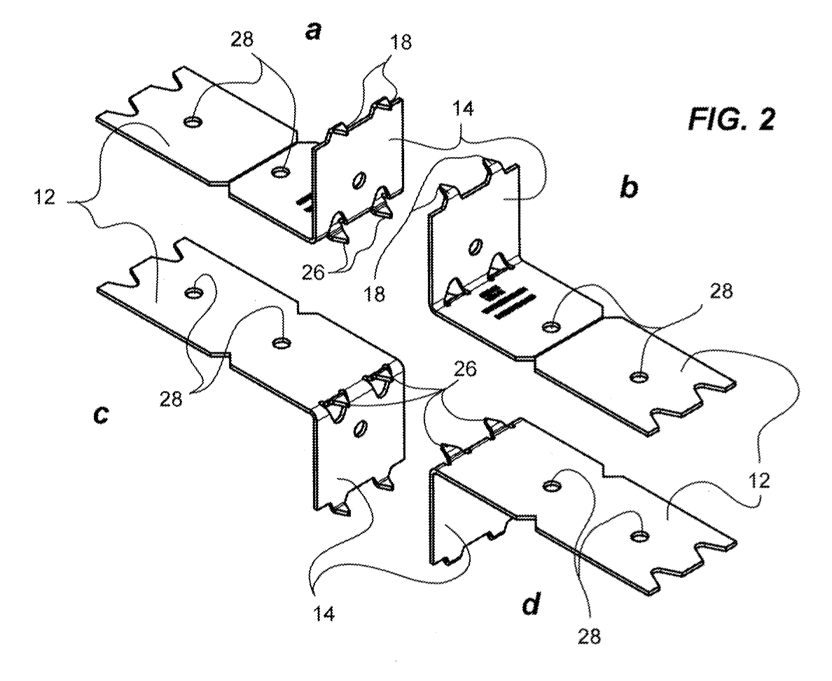

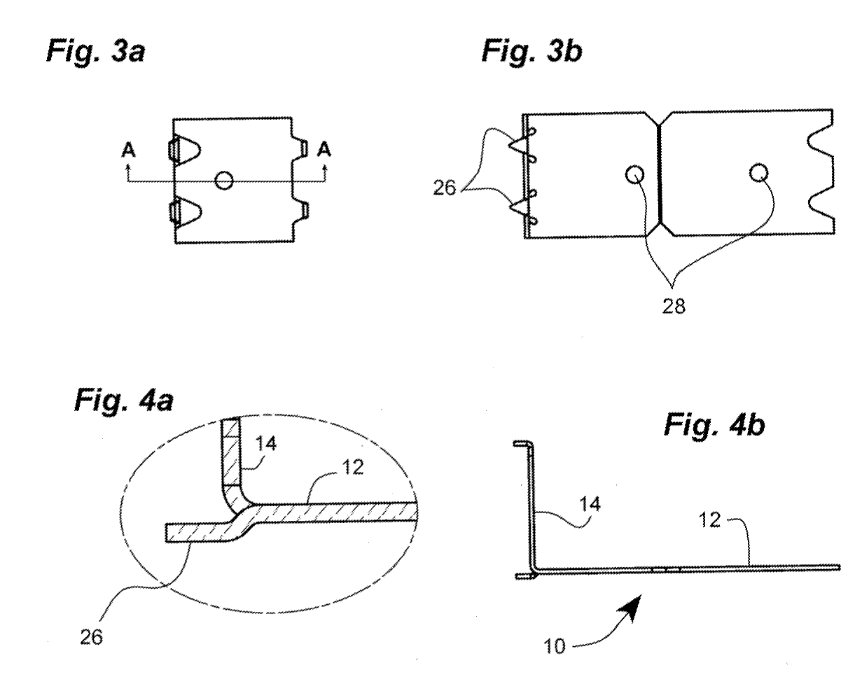

In the case where a new window is installed as replacement for an old window such as in the case of a renovation, as seen in FIG. 1b, since the finished interior wall (24) is already there, the attachment bracket (10) is set up in reverse so that the long section (12), with the help of the short section teeth (26), is positioned in such a way that when set against the finished wall (24) the window casing (16) is flush with the finished interior wall (24). In this configuration, the stud guides (18) are now used for tacking into the window casing (16) in lieu of the short section teeth (26).

In both types of installation, that is on a new construction or a renovation, the attachment bracket (10) is fixedly attached to the window casing (16) and to the framing studs (22) or finished interior wall (24) by way of mechanical fasteners passing through holes (28).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An attachment bracket for positioning a window or door casing comprising:
a long section and a short section;
short section teeth for tacking the attachment bracket to the window casing;
stud guides to provide positioning of the window casing relative to framing studs;
the short section teeth also being used for positioning the attachment bracket onto a finished interior wall;
holes made into the attachment bracket to allow mechanical fateners to attach the attachment bracket.

2. An attachment bracket as in claim 1 for use in installing a window casing on a new construction having a method of installation consisting of the steps of:
tacking and mechanically fastening one attachment bracket on one side of the bottom of the window casing using short section teeth with the stud guides being positioned just off the window casing's edge towards the interior of the dwelling;
tacking and mechanically fastening a second attachment bracket on the same side and in a similar fashion but at the top of the window casing also installed using short section teeth with the stud guides being positioned just off the window casing's edge towards the interior of the dwelling;
tacking and mechanically fastening two more attachment brackets on the opposite side of the window casing with one at the bottom of the window casing and the other at the top of the window casing also installed using short section teeth with the stud guides being positioned just off the window casing's edge towards the interior of the dwelling;
mechanically fastening one of the four attachment bracket to a stud;
leveling the window casing;
mechanically fastening the second attachment bracket;
mechanically fastening the remaining attachment brackets.

3. An attachment bracket as in claim 1 for use in installing a window casing as a replacement for an existing window having a method of installation consisting of the steps of:
tacking and mechanically fastening one attachment bracket on one side of the bottom of the window casing so that the long section, with the help of the short section teeth, is positioned in such a way that when set against the finished wall the window casing is flush with the finished interior wall; tacking and mechanically fastening a second attachment bracket on
the same side and in a similar fashion but at the top of the window casing also installed using short section teeth with the stud guides being positioned just off the window casing's edge towards the interior of the dwelling;
tacking and mechanically fastening two more attachment brackets on the opposite side of the window casing with one at the bottom of the window casing and the other at the top of the window casing also installed using short section teeth with the stud guides being positioned just off the window casing's edge towards the interior of the dwelling;
mechanically fastening one of the four attachment bracket to a stud;
leveling the window casing;
mechanically fastening the second attachment bracket;
mechanically fastening the remaining attachment brackets.
